(19) United States
(12) Patent Application Publication
(10) Pub. No.: US 2013/0275788 A1
(43) Pub. Date: Oct. 17, 2013

(54) INFORMATION PROCESSING DEVICE, METHOD FOR CALCULATING DEGREE OF CONTRIBUTION TO POWER SAVING, AND PRESENTATION METHOD

(71) Applicant: Kabushiki Kaisha Toshiba, Tokyo (JP)

(72) Inventor: Yasuyuki Mizuura, Tokyo (JP)

(21) Appl. No.: 13/915,361

(22) Filed: Jun. 11, 2013

Related U.S. Application Data
(63) Continuation of application No. 13/215,865, filed on Aug. 23, 2011.

(30) Foreign Application Priority Data
Mar. 30, 2011 (JP) 2011-076172

(51) Int. Cl. G06F 1/32

(52) U.S. Cl. CPC G06F 1/32
USPC 713/320

(57) ABSTRACT

According to an embodiment, an information processing device includes a storage section, a computing section, and an index calculating section. The storage section stores a current set value for each of the at least one setting item associated with saving of power consumed by a computer and table data including a score defined in advance for each of set values. The computing section performs a computation for converting the current set value into a score and a computation for converting a most power-saving one of the set values into a score on the basis of a result of checking the current set values at fixed intervals and the scores in the table data. The index calculating section calculates an index of how much drive status of the computer with the current set values contributes to power saving on the basis of results of the computations from the computing section.

### CROSS-REFERENCE TO RELATED APPLICATION

This application is a continuation of U.S. application Ser. No. 13/215,865, filed Aug. 23, 2011, which is based upon and claims the benefit of priority from Japanese Patent Application No. 2011-076172, filed in Japan on Mar. 30, 2011; the entire contents of both of which are incorporated herein by reference.

### FIELD

An embodiments described herein relates generally to an information processing device, a method for calculating a degree of contribution to power saving, and a presentation method.

### BACKGROUND

For example, a technique has been known that can present a recommended parameter or an index which increases a rate of reduction in consumed power in a personal computer or the like.

According to the conventional technique, for example, if settings based on the recommended parameter or the index are made in a computer designed to be driven with high performance, a sufficient power-saving effect is achieved. In contrast, if settings based on the recommended parameter or the index are made in a computer designed to be driven with saved power, a sufficient power-saving effect is hard to achieve. Accordingly, the conventional technique faces a difficulty in developing a user's awareness of power saving.

### BRIEF DESCRIPTION OF THE DRAWINGS

FIG. 1 is a diagram showing a main portion of a computer including an information processing device according to an embodiment;

FIG. 2 is a chart showing an example of table data used in processing by the information processing device according to the embodiment;

FIG. 3 is a view showing a display example of a report screen indicating a result of evaluating the degree of contribution to power saving;

FIG. 4 is a view showing an example of an evaluation result image used to generate the report screen in FIG. 3;

FIG. 5 is a view showing an example of an evaluation result image used to generate the report screen in FIG. 3 that is different from the example in FIG. 4;

FIG. 6 is a view showing an example of an evaluation result image used to generate the report screen in FIG. 3 that is different from the examples in FIGS. 4 and 5;

FIG. 7 is a view showing an example of an evaluation result image used to generate the report screen in FIG. 3 that is different from the examples in FIGS. 4, 5, and 6;

FIG. 8 is a view showing an example of an evaluation result image used to generate the report screen in FIG. 3 that is different from the examples in FIGS. 4, 5, 6, and 7; and

FIG. 9 is a view showing an example of an evaluation result image used to generate the report screen in FIG. 3 that is different from the examples in FIGS. 4, 5, 6, 7, and 8.

### DETAILED DESCRIPTION

According to an embodiment, an information processing device includes a storage section, a computing section, and an index calculating section. The storage section stores setting data including at least one setting item associated with saving of power consumed by a computer and a current set value for each of the at least one setting item and table data including a score defined in advance for each of set values for the at least one setting item. The computing section is configured to perform a computation for converting the current set value for each of the setting items into a score and a computation for converting a most power-saving one of the set values for each setting item into a score on the basis of a result of checking the current set value for each of the setting items included in the setting data at fixed intervals and the scores in the table data. The index calculating section is configured to calculate an index of how much drive status of the computer with the current set values included in the setting data contributes to power saving on the basis of results of the computations from the computing section.

An embodiment will be described below with reference to the drawings.

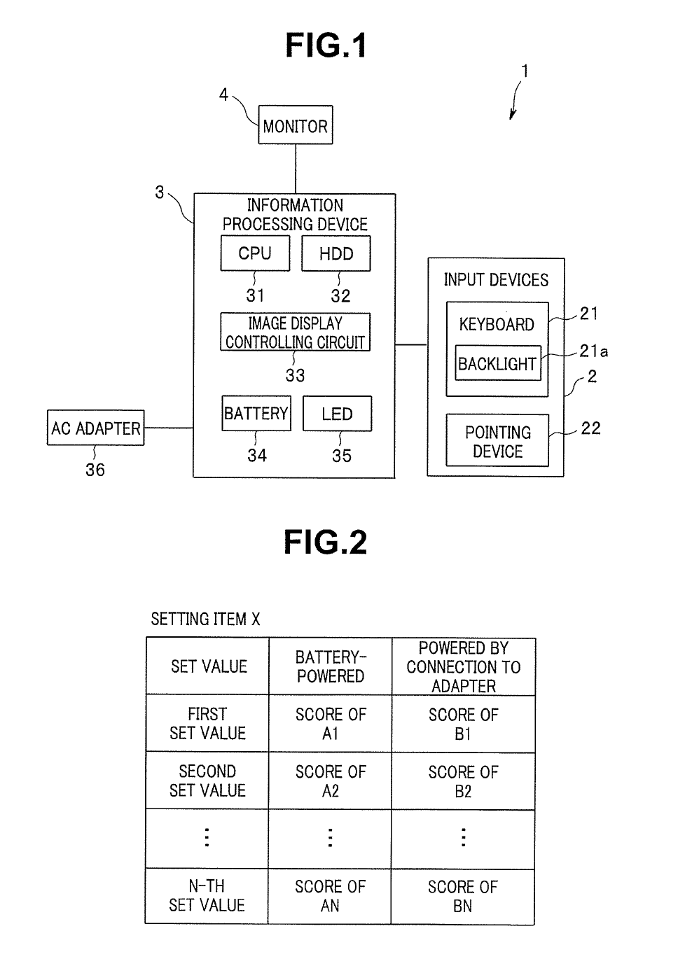

FIG. 1 is a diagram showing a main portion of a computer including an information processing device according to the embodiment.

A computer 1 includes input devices 2, an information processing device 3, and a monitor 4, as shown in FIG. 1.

The input devices 2 include a keyboard 21 which is provided with a backlight 21a for illuminating a dial (not shown) and a pointing device 22.

The information processing device 3 includes a CPU 31, a HDD (hard disk drive) 32, an image display controlling circuit 33, a battery 34, an LED 35 for illumination, and an AC adapter 36.

The CPU 31 that functions as a computing section is configured to be capable of controlling each section of the computer 1 by reading a piece of software, a program, and the like stored in the HDD 32 and performing processing based on the read piece of software, program, and the like.

The HDD 32 that functions as a storage section stores setting data including at least one setting item associated with saving of power consumed by the computer 1 and a current set value for each of the at least one setting item and table data for each setting item of the setting data, in addition to a piece of software and the like to be executed by the CPU 31. When the CPU 31 detects that a manipulation for changing the current set value for each setting item included in the setting data has been performed at the input devices 2, the CPU 31 updates the current set value with a new set value.

Note that a set value for each setting item of the setting data is separately defined for a case where the computer 1 is driven by power supplied from the battery 34 as an internal power source and for a case where the computer 1 is driven by power supplied from the AC adapter 36 as an external power source.

The table data will now be described. FIG. 2 is a chart showing an example of table data used in processing by the information processing device according to the embodiment.

More specifically, the HDD 32 stores table data including separate scores which are defined in advance for a case where the computer 1 is driven by power supplied from the battery 34 as the internal power source and a case where the computer 1 is driven by power supplied from the AC adapter 36 as the external power source for each of set values (a first to an N-th set values) for a setting item X associated with saving of power consumed by the computer 1, as shown in, e.g., FIG. 2.

Note that scores of A1 to AN and scores of B1 to BN in the table data illustrated in FIG. 2 are each defined in advance to be a number not less than 0 and not more than 100 in the present embodiment.

The image display controlling circuit 33 is configured to be capable of generating various GUIs and displaying the GUIs on the monitor 4 under control of the CPU 31.

The battery 34 is a chargeable/dischargeable secondary battery or the like and is configured to be capable of accumulating and supplying power used to drive the sections of the computer 1.

The AC adapter 36 includes, e.g., an attachment plug connectable to a receptacle of a commercial power source or the like as an external power source and is configured to be capable of converting AC power obtained from the commercial power source into DC power and supplying the DC power to the information processing device 3. When CPU 31 detects that power is supplied from the AC adapter 36, the CPU 31 drives the sections of the computer 1 by power supplied from the AC adapter 36 and controls the battery 34 to accumulate power. When the CPU 31 detects that power is not supplied from the AC adapter 36, the CPU 31 performs control to drive the sections of the computer 1 by power accumulated in the battery 34.

The monitor 4 includes an LCD panel or the like and is configured to be capable of changing power on/off status, brightness of a screen, and the like under control of the information processing device 3.

Specific operation of the computer 1 with the above-described configuration will be described.

During a period from when the computer 1 is turned on to when the computer 1 is turned off, the CPU 31 performs a process of checking presence or absence of supply of power from the AC adapter 36 and checking setting items associated with power saving and current set values for the setting items included in setting data stored in the HDD 32 with every preset period TM (e.g., every 5 seconds).

More specifically, the CPU 31 checks the setting items associated with power saving and, e.g., a set level of brightness of the monitor 4, a time to when the monitor 4 on standby (in a state in which the input devices 2 are not manipulated) is dimmed, a set level of brightness of the monitor 4 when the monitor 4 is dimmed, a time to when the monitor 4 is turned off, e.g., when the input devices 2 are not manipulated, a time to when the HDD 32 is turned off, e.g., when the input devices 2 are not manipulated, a time to when the computer 1 is caused to enter sleep mode, e.g., when the input devices 2 are not manipulated, a set value associated with turning on or off of the LED 35, and a set value associated with turning on or off of the backlight 21a of the keyboard 21 as set values for the setting items included in the setting data stored in the HDD 32 with every preset period TM.

After that, the CPU 31 performs a process of acquiring a score based on a result of checking the presence or absence of supply of power from the AC adapter 36 and a result of checking the setting item X associated with power saving and a set value for the setting item X by referring to table data stored in the HDD 32 and storing the acquired score in the HDD 32.

More specifically, for example, if a check result indicating that power is supplied from the AC adapter 36 and that the set value for the setting item X is the first set value is obtained, the CPU 31 acquires the score of B1 for the setting item X by referring to the table data illustrated in FIG. 2 and stores the acquired score of B1 in the HDD 32.

In other words, the CPU 31 refers to the table data as illustrated in FIG. 2, acquires a score for the setting item X, and stores the acquired score in the HDD 32 with every period TM.

Meanwhile, the CPU 31 calculates a point score Point[X] for the setting item X by substituting an integrated value RD[X] obtained by integrating scores for the setting item X stored in the HDD 32 and a weighting factor G[X] for the setting item X into Equation (1) below:

Point[X]=RD[X]×G[X] (1)

In other words, the CPU 31 calculates point scores Point[X1] to Point[XS] for S setting items X1 to XS corresponding to a check result as described above by performing a computation using Equation (1) above.

The CPU 31 calculates a total point score Point[All] as an index of level of power-saving performance corresponding to drive status of the computer 1 with current set values by adding up the point scores Point[X1] to Point[XS].

The CPU 31 assumes that a score of a most power-saving set value for the setting item X is 100 and calculates a highest point score Best[X] for the setting item X by substituting the number TMC of repetitions of the period TM and the weighting factor G[X] for the setting item X into Equation (2) below:

Best[X]=100×TMC×G[X] (2)

In other words, the CPU 31 calculates highest point scores Best[X1] to Best[XS] for the S setting items X1 to XS corresponding to a check result as described above by performing a computation using Equation (2) above.

The CPU 31 calculates a total point score Best[All] as an index of level of power-saving performance when the computer 1 is driven with most power-saving set values by adding up the point scores Best[X1] to Best[XS].

After that, the CPU 31 that functions as an index calculating section calculates a contribution degree DC[All] as an index of how much the drive status of the computer 1 with the current set values contributes to power saving (expressed as a percentage) by substituting the total point score Point[All] and the total point score Best[All] into Equation (3) below:

DC[All]=(Point[All]/Best[All])×100 (3)

The CPU 31 that functions as an evaluation section determines within which one of numerical ranges a result of calculating the contribution degree DC[All] falls and performs an evaluation based on a result of the determination.

More specifically, for example, the CPU 31 rates contribution status of the computer 1 as “Poor” if the result of calculating the contribution degree DC[All] is not less than 0 and not more than 50, rates the contribution status as “Fair” if the result of calculating the contribution degree DC[All] is not less than 51 and not more than 70, and rates the contribution status as “Good” if the result of calculating the contribution degree DC[All] is not less than 71 and not more than 100.

The CPU 31 stores an evaluation result obtained by the evaluation as a piece of evaluation log data in the HDD 32.

When the CPU 31 detects that instructions to display the result of evaluating the contribution degree on the monitor 4 are given from the input devices 2 by, e.g., a depression of a “Report” button displayed as a GUI on the monitor 4, the CPU 31 reads a piece of evaluation log data stored in the HDD 32 and controls the image display controlling circuit 33 to generate a report screen corresponding to the read piece of evaluation log data.

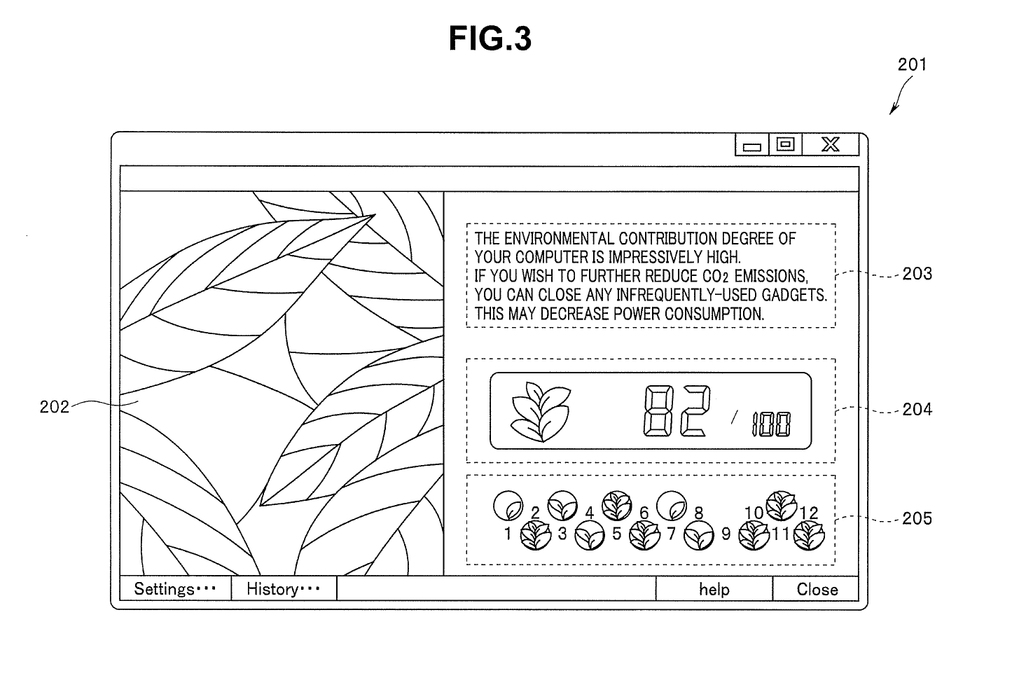

The image display controlling circuit 33 that functions as a screen generating section generates a report screen 201 having, e.g., a layout as shown in FIG. 3 that allows visual presentation of a latest value of the contribution degree DC[All] and a latest evaluation result and results of past several evaluations of the contribution degree DC[All] and displays the report screen 201 on the monitor 4 under control of the CPU 31.

FIG. 3 is a view showing a display example of a report screen indicating a result of evaluating the degree of contribution to power saving.

An evaluation result image (of large size) corresponding to a result of a latest evaluation of the contribution degree DC[All] is displayed in an evaluation result image displaying area 202 located on a left side of the report screen 201.

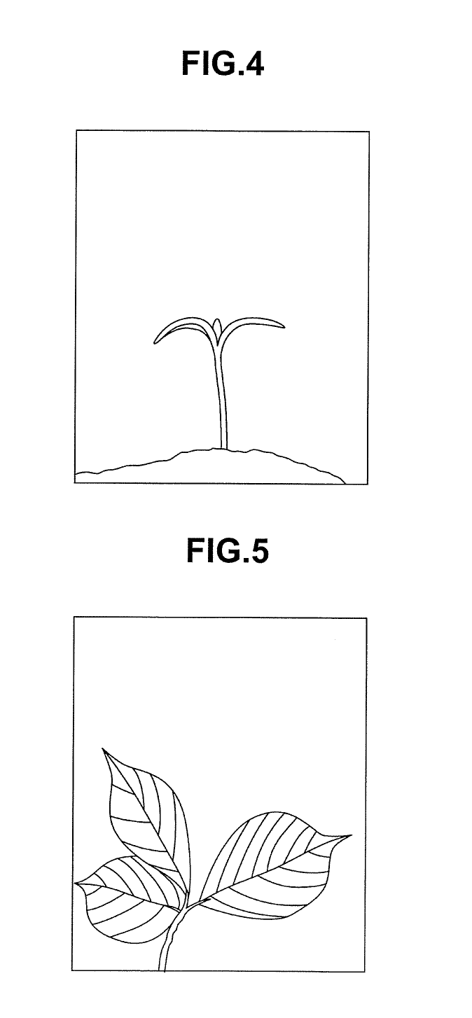

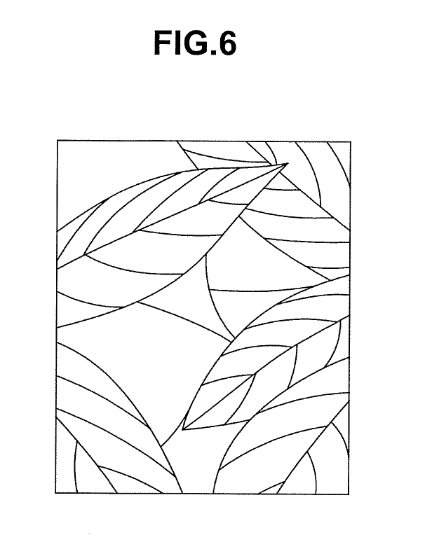

FIG. 4 is a view showing an example of an evaluation result image used to generate the report screen in FIG. 3. FIG. 5 is a view showing an example of an evaluation result image used to generate the report screen in FIG. 3 that is different from the example in FIG. 4. FIG. 6 is a view showing an example of an evaluation result image used to generate the report screen in FIG. 3 that is different from the examples in FIGS. 4 and 5.

More specifically, for example, if the result of the latest evaluation of the contribution degree DC [All] corresponds “Poor” described above, an image illustrated in FIG. 4 is displayed in the evaluation result image displaying area 202. If the result of the latest evaluation of the contribution degree DC[All] corresponds to “Fair” described above, an image illustrated in FIG. 5 is displayed in the evaluation result image displaying area 202. If the result of the latest evaluation of the contribution degree DC[All] corresponds to “Good” described above, an image illustrated in FIG. 6 is displayed in the evaluation result image displaying area 202.

A message (a character string) corresponding to the result of the latest evaluation of the contribution degree DC[All] and (or) the results of the past several evaluations of the contribution degree DC[All] is displayed in a message displaying area 203 located at a top on a right side of the report screen 201.

More specifically, for example, if an evaluation result corresponding to “Good” described above appears at least a predetermined number of times among the result of the latest evaluation of the contribution degree DC[All] and the results of the past several evaluations of the contribution degree DC[All], a message prompting continuation of power-saving driving with the current set values is displayed in the message displaying area 203. For example, if the result of the latest evaluation of the contribution degree DC[All] is worse than a result of a second latest evaluation of the contribution degree DC[All], a message prompting a review of the current set values is displayed in the message displaying area 203.

A latest value of the contribution degree DC[All] and an evaluation result image (of small size) corresponding to the result of the latest evaluation of the contribution degree DC [All] are displayed together in a contribution degree displaying area 204 located at a middle on the right side of the report screen 201.

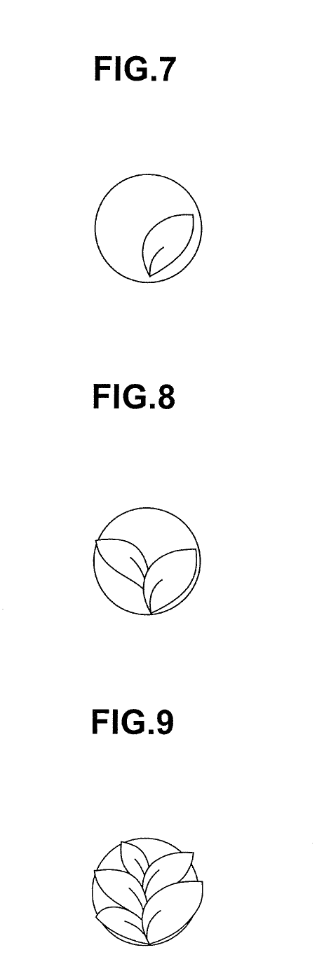

FIG. 7 is a view showing an example of an evaluation result image used to generate the report screen in FIG. 3 that is different from the examples in FIGS. 4, 5, and 6. FIG. 8 is a view showing an example of an evaluation result image used to generate the report screen in FIG. 3 that is different from the examples in FIGS. 4, 5, 6, and 7. FIG. 9 is a view showing an example of an evaluation result image used to generate the report screen in FIG. 3 that is different from the examples in FIGS. 4, 5, 6, 7, and 8.

More specifically, for example, what the latest value of the contribution degree DC[All] is out of 100 is displayed in the contribution degree displaying area 204. For example, if the result of the latest evaluation of the contribution degree DC[All] corresponds to “Poor” described above, an image illustrated in FIG. 7 is displayed in the contribution degree displaying area 204. If the result of the latest evaluation of the contribution degree DC[All] corresponds to “Fair” described above, an image illustrated in FIG. 8 is displayed in the contribution degree displaying area 204. If the result of the latest evaluation of the contribution degree DC[All] corresponds to “Good” described above, an image illustrated in FIG. 9 is displayed in the contribution degree displaying area 204.

Evaluation result images (of small size) corresponding to the results of the past several evaluations of the contribution degree DC[All] are displayed in an evaluation log displaying area 205 located at a bottom on the right side of the report screen 201.

More specifically, for example, if a result of a past evaluation of the contribution degree DC [All] corresponds to “Poor” described above, the image illustrated in FIG. 7 is displayed in the evaluation log displaying area 205. If the result of the past evaluation of the contribution degree DC[All] corresponds to “Fair” described above, the image illustrated in FIG. 8 is displayed in the evaluation log displaying area 205. If the result of the past evaluation of the contribution degree DC[All] corresponds to “Good” described above, the image illustrated in FIG. 9 is displayed in the evaluation log displaying area 205.

Note that the images illustrated in FIGS. 4 to 9 may be generated by the image display controlling circuit 33 when the report screen 201 is generated or may be read from the HDD 32.

The report screen 201 generated by the image display controlling circuit 33 is not limited to one as illustrated in FIG. 3. Any other screen may be adopted as long as the screen includes at least one of an image and a character string.

According to the above-described embodiment, a contribution degree DC[All] is calculated to be a same value in, e.g., both a computer designed to be driven with high performance and a computer designed to be driven with saved power as far as the computers have same current set values for setting items associated with saving of power consumed by a computer. For the reason, according to the above-described embodiment, development of a user's awareness of power saving can be made easier than ever before.

While a certain embodiment has been described, the embodiment has been presented by way of example only, and are not intended to limit the scope of the inventions, Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. An information processing device comprising:
a storage section configured to store setting data including at least one setting item associated with saving of power consumed by a computer and a current set value for each of the at least one setting item and table data including a score defined in advance for each of set values for each of the at least one setting item;
a computing section configured to perform a computation for converting the current set value for each setting item into a score and a computation for converting a most power-saving one of the set values for each setting item into a score on the basis of a result of checking the current set values for the at least one setting item included in the setting data at fixed intervals and the scores in the table data;
an index calculating section configured to calculate an index of how much drive status of the computer with the current set values included in the setting data contributes to power saving on the basis of computation results from the computing section; and
a screen generating section configured to generate a reporting screen that allows a value corresponding to a latest result of calculating the index by the index calculating section and a maximum value of the index which can be calculated by the index calculating section to be displayed together in a predetermined area.

2. The information processing device according to claim 1, further comprising:
an evaluation section configured to determine within which one of numerical ranges a result of calculating the index by the index calculating section falls and perform an evaluation based on a result of the determination; and
the screen generating section generates a reporting screen that allows the value corresponding to the latest result of calculating the index by the index calculating section, the maximum value of the index which can be calculated by the index calculating section, and an image corresponding to one latest evaluation result from the evaluation section to be displayed together in the predetermined area.

3. The information processing device according to claim 2, wherein the screen generating section generates a reporting screen that allows at least one another evaluation result obtained from the evaluation section before obtainment of the one latest evaluation result to be displayed in an area different from the predetermined area.

4. A method comprising:
checking a current set value for each of at least one setting item associated with saving of power consumed by a computer at fixed intervals;
performing a computation, by circuitry within the computer, for converting the current set value for each setting item into a score and a computation for converting a most power saving one of set values for each setting item into a score on the basis of a check result obtained from the checking and scores in table data which are defined in advance for the respective set values for the at least one setting item;
calculating, by circuitry within the computer, an index of how much drive status of the computer with the current set values for the at least one setting item contributes to power saving on the basis of computation results obtained from the computations; and
generating, by circuitry within the computer, a reporting screen that allows a value corresponding to a latest result of calculating the index obtained from the index calculation and a maximum value of the index which can be calculated by the index calculation to be displayed together in a predetermined area.

5. The method according to claim 4, further comprising
determining within which one of numerical ranges a result of calculating the index obtained from the index calculation falls and performing an evaluation based on a result of the determination, wherein
the generating the reporting screen includes generating a reporting screen that allows the value corresponding to the latest result of calculating the index obtained from the index calculation, the maximum value of the index which can be calculated by the index calculation, and an image corresponding to one latest evaluation result from the evaluation to be displayed together in the predetermined area.

6. The method according to claim 5, wherein the generating the reporting screen includes generating a reporting screen that allows at least one another evaluation result obtained from the evaluation before obtainment of the one latest evaluation result to be displayed in an area different from the predetermined area.

7. An apparatus comprising:
a storage device configured to store setting data including at least one setting item associated with saving of power consumed by a computer and a current set value for each of the at least one setting item and table data including a score defined in advance for each of set values for each of the at least one setting item;
a processor configured to (1) perform a computation for converting the current set value for each setting item into a score and a computation for converting a most power-saving one of the set values for each setting item into a score on the basis of a result of checking the current set values for the at least one setting item included in the setting data at fixed intervals and the scores in the table data, and (2) calculate an index of how much drive status of the computer with the current set values included in the setting data contributes to power saving on the basis of computation results from the processor; and
a image display controlling circuit configured to generate a reporting screen that allows a value corresponding to a latest result of calculating the index by the processor and a maximum value of the index which can be calculated by the processor to be displayed together in a predetermined area.

8. The apparatus according to claim 7, further comprising:
an evaluation section configured to determine within which one of numerical ranges a result of calculating the index by the processor falls and perform an evaluation based on a result of the determination; and
the image display controlling circuit generates a reporting screen that allows the value corresponding to the latest result of calculating the index by the processor, the maximum value of the index which can be calculated by the processor, and an image corresponding to one latest evaluation result from the evaluation section to be displayed together in the predetermined area.

9. The apparatus according to claim 8, wherein
the image display controlling circuit generates a reporting screen that allows at least one another evaluation result obtained from the evaluation section before obtainment of the one latest evaluation result to be displayed in an area different from the predetermined area.
